(19) United States
(12) Patent Application Publication
(10) Pub. No.: US 2026/0121495 A1
(43) Pub. Date: Apr. 30, 2026

(54) METHOD FOR MANUFACTURING A ROTOR ASSEMBLY OF A CANNED MOTOR PUMP

(71) Applicant: ZI YI ELECTRICAL ENGINEERING CO., LTD., Taichung City (TW)

(72) Inventor: Ting-Tsai HUANG, Taichung City (TW)

(73) Assignee: ZI YI ELECTRICAL ENGINEERING CO., LTD., Taichung City (TW)

(21) Appl. No.: 18/929,195

(22) Filed: Oct. 28, 2024

(51) Int. Cl. H02K 15/12; H02K 15/02

(52) U.S. Cl. CPC H02K 15/12; H02K 15/02; H02K 2213/03; H02K 2215/00

(57) ABSTRACT

A method for manufacturing a rotor assembly of a canned motor pump includes: providing an injection mold; a heat press apparatus, a rotor unit and a rotor base seat; disposing the rotor unit in a mold cavity of the mold to be positioned by an injector pin unit; injecting a plastic material into the cavity to be formed as an overmolding unit which covers the rotor unit and a portion of the injector pin unit; removing a semi-finished product which has a rotor-side connecting part; and disposing the rotor base seat on the rotor-side connecting part, and disposing them in the heat press apparatus for performing heating and pressing operations such that the rotor base seat is bonded to the semi-finished product in thermal welding and pressing processes.

### FIELD

The disclosure relates to a canned motor pump, and more particularly to a method for manufacturing a rotor assembly of a canned motor pump.

### BACKGROUND

A conventional canned motor pump disclosed in US 2023/0238854 includes a base, a fixed seat, a motor unit, a motor cover and a main cover. A rotor of the motor unit has a metal magnetic part and a plastic overmolding covering the metal magnetic part formed by an overmolding process. In the overmolding process, the metal magnetic part may be deflected in the plastic overmolding. It is difficult to observe the deflected metal magnetic part which is covered by the plastic overmolding. Hence, dynamic balancing for the rotor is required for adjustment of the rotor's balance. However, unbalance of the rotor cannot be corrected by adding or removing weight thereof. Therefore, the above manufacturing method may lead to inconsistent deflection of the metal magnetic part, thereby affecting the product quality of the canned motor pump.

### SUMMARY

Therefore, an object of the disclosure is to provide a method for manufacturing a rotor assembly of a canned motor pump that can alleviate at least one of the drawbacks of the prior art.

According to the disclosure, the method for manufacturing a rotor assembly of a canned motor pump includes the steps of: (A) providing an injection mold, a heat press apparatus, a rotor unit and a rotor base seat. The injection mold has a mold cavity and an injector pin unit securely mounted in the mold cavity. The rotor base seat is made of plastic materials; (B) disposing the rotor unit in the mold cavity of the injection mold in a mold opened state of the injection mold, wherein the rotor unit is supported and positioned by the injector pin unit, and then operating the injection mold from the mold opened state to a mold closed state; (C) injecting a plastic material into the mold cavity of the injection mold. The injected plastic material is formed as an overmolding unit which covers the rotor unit and a portion of the injector pin unit; (D) cooling the injection mold, operating the injection mold from the mold closed state to the mold opened state, and removing a semi-finished product from the mold cavity. The semi-finished product having a rotor-side connecting part formed by the injector pin unit; and (E) disposing the rotor base seat on the rotor-side connecting part, and disposing the rotor base seat and the semi-finished product in the heat press apparatus for performing heating and pressing operations. The rotor base seat is bonded to the rotor-side connecting part of the semi-finished product in thermal welding and pressing processes.

### BRIEF DESCRIPTION OF THE DRAWINGS

Other features and advantages of the disclosure will become apparent in the following detailed description of the embodiment with reference to the accompanying drawings. It is noted that various features may not be drawn to scale.

FIG. 1 is a flow diagram illustrating the steps in an embodiment of a method for manufacturing a rotor assembly of a canned motor pump according to the disclosure.

FIG. 2 is a sectional view illustrating a canned motor pump employed with the rotor assembly manufactured by the method of the embodiment.

FIG. 3 is an exploded perspective view illustrating the canned motor pump employed with the rotor assembly manufactured by the method of the embodiment.

FIG. 4 is a schematic sectional view illustrating the rotor assembly in an injection process.

FIG. 5 is a sectional view taken along line V-V of FIG. 4.

FIG. 6 is a schematic sectional view illustrating the rotor assembly in a thermal welding process.

FIG. 7 is a schematic sectional view illustrating the rotor assembly in a pressing process.

FIG. 8 is a sectional view illustrating the rotor assembly manufactured by the method of the embodiment.

FIG. 9 is a sectional view taken along line IX-IX of FIG. 8.

FIG. 10 is an exploded perspective view illustrating the rotor assembly manufactured by the method of the embodiment.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

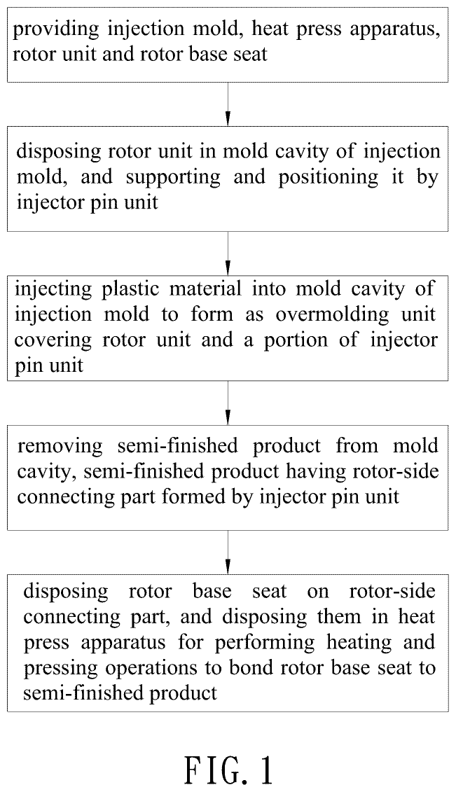

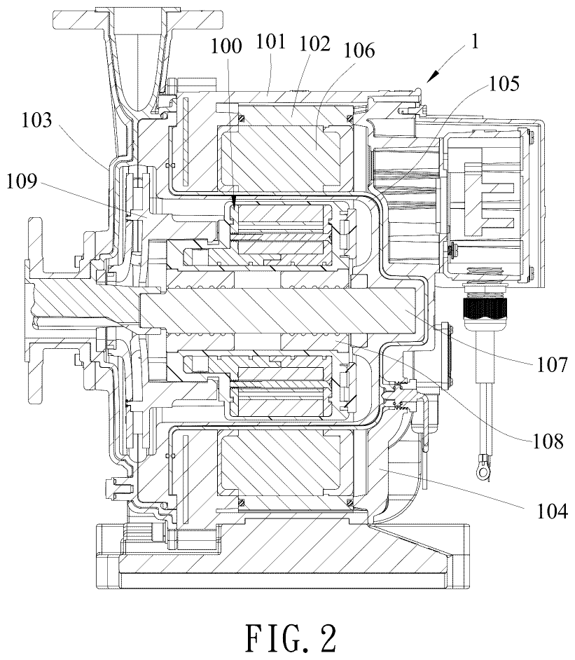

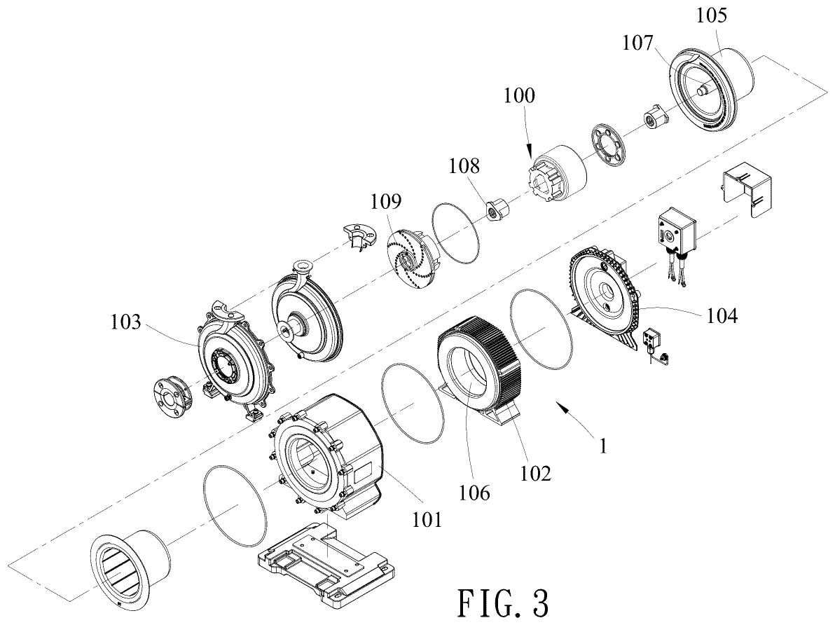

Referring to FIGS. 1 to 3, an embodiment of a method for manufacturing a rotor assembly 100 according to the disclosure is illustrated. The rotor assembly 100 is applied to a canned motor pump 1. The canned motor pump 1 further includes a base frame 101, a fixed seat 102 disposed within the base frame 101, a front cover 103 mounted on a side of the base frame 101, a rear cover 104 mounted on an opposite side of the base 101, a casing 105 mounted within the base frame 101, a stator 106 interposed between the casing 105 and the fixed seat 102, a shaft 107 mounted within the casing 105, a bearing unit 108 and an impeller 109. The rotor assembly 100 is mounted within the casing 105 and is supported by the shaft 107. The impeller 109 is connected with the rotor assembly 100. The bearing unit 108 is interposed between the rotor assembly 100 and the shaft 107.

The method for manufacturing the rotor assembly 100 of the embodiment includes the following steps.

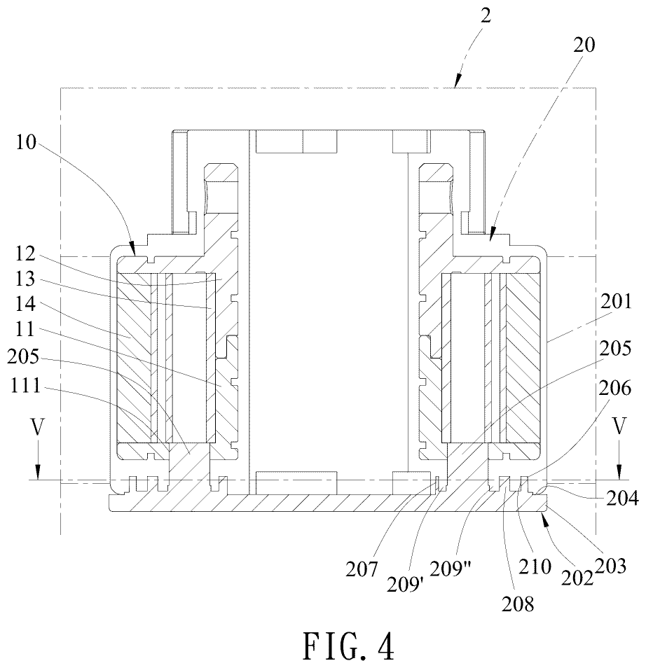

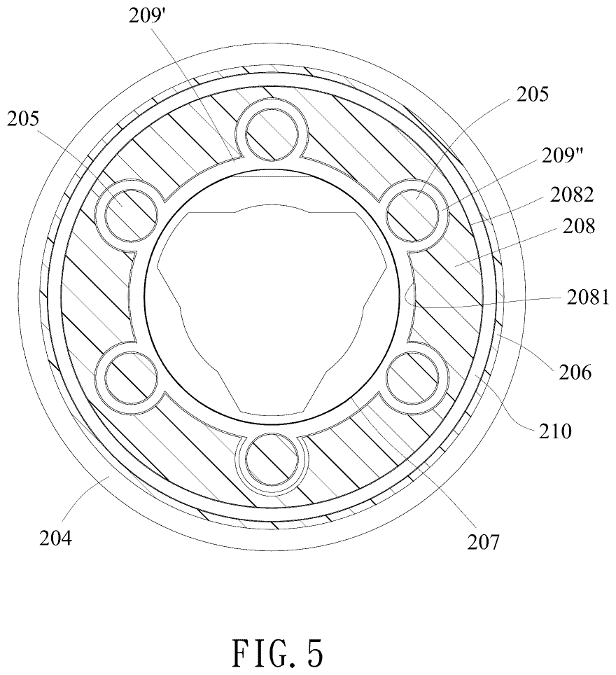

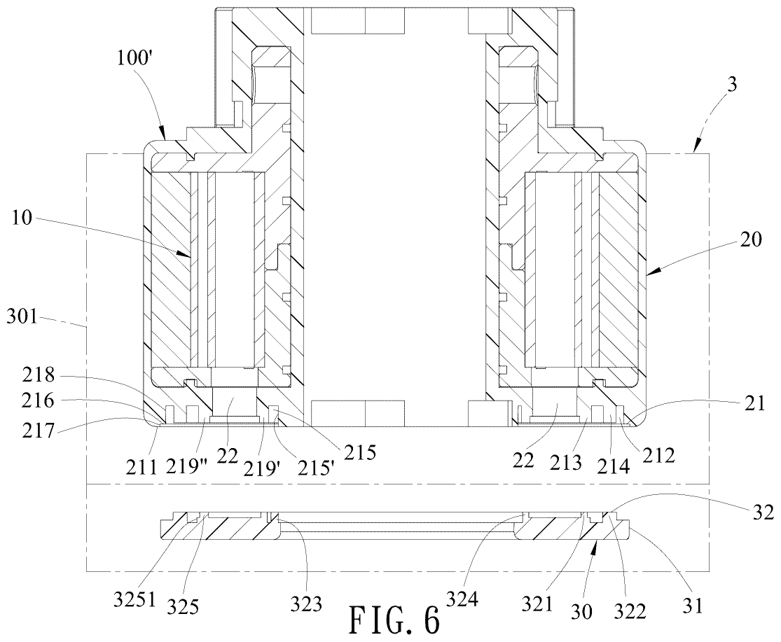

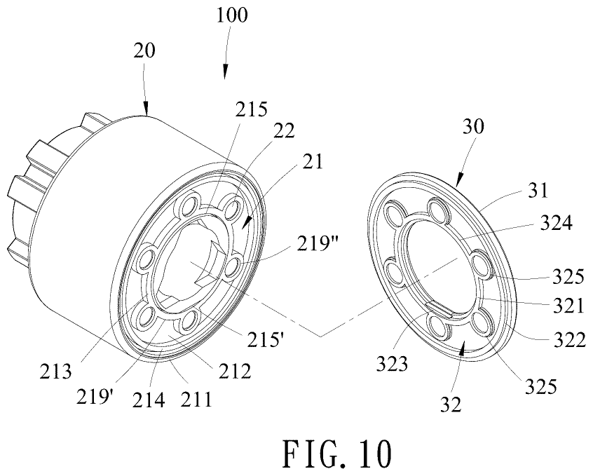

In step (A), an injection mold 2 (see FIG. 4), a heat press apparatus 3 (see FIG. 6), a rotor unit 10 and a rotor base seat 30 are provided. With reference to FIG. 4, the injection mold 2 has a mold cavity 201 and an injector pin unit 202 securely mounted in the mold cavity 201. With reference to FIGS. 4 and 5, the injector pin unit 202 has a base frame 203, a raised portion 204 connected with the base frame 203, a plurality of ejector pins 205 disposed on the raised portion 204 and angularly spaced apart from each other, an outer surrounding rib 206 disposed on the raised portion 204 and surrounding the ejector pins 205, an inner surrounding rib 207 disposed on the raised portion 204 and radially and inwardly of the ejector pins 205, and a surrounding ring 208 disposed on the raised portion 204 and interposed between the outer surrounding rib 206 and the inner surrounding rib 207. Each ejector pin 205 is in the form of a stepped pin. The surrounding ring 208 has an outer peripheral surface 2082 which is spaced apart from the outer surrounding rib 206 to define an outer annular groove 210 therebetween, and an inner peripheral surface 2081 which is spaced apart from the inner surrounding rib 207 to define a primary annular grooved portion 209′ therebetween, and which is spaced apart from each of the injector pins 205 to define a secondary annular grooved portion 209′ therebetween that is in spatial communication with the primary annular grooved portion 209′. With reference to FIGS. 4, 6 and 7, the heat press apparatus 3 has a heating unit 301 and a pressing unit 302. The rotor unit 10 has a lower metal element 11, an upper metal element 12, a laminated steel 13 and a magnet assembly 14. The lower metal element 11 has a plurality of engaging holes 111 for respectively aligning with the injector pins 205. With reference to FIG. 10, the rotor base seat 30 includes a flat base plate 31 and a seat-side connecting part 32 disposed on the base plate 31. The seat-side connecting part 32 has a seat inner connecting ring 321 connected with the base plate 31, a seat outer connecting ring 322 connected with the base plate 31 and surrounding the seat inner connecting ring 321, and an aligning protrusion 323 extending radially and inwardly from an inner periphery of the seat inner connecting ring 321. The seat inner connecting ring 321 has a primary connecting ring portion 324 and a plurality of secondary connecting ring portions 325 connected with the primary connecting ring portion 324 and angularly spaced apart from each other. Each secondary connecting ring portion 325 has an outer surrounding ring surface 3251 in the form of a stepped surrounding surface. The rotor base seat 30 is made of a plastic material that is acid and alkalis resistant and corrosion resistant, and is selected from polypropylene (PP), polyvinylidene difluoride (PVDF) and carbon fiber filled ETFE (CFETFE). The polypropylene has a melting point of 167° C. The polyvinylidene difluoride has a melting point of 171° C. The carbon fiber filled ETFE has a melting point of 256-180° C.

In step (B), in a mold opened state (not shown) of the injection mold 2, the rotor unit 10 is disposed in the mold cavity 201 of the injection mold 2, and the ejector pins 205 are respectively inserted into the engaging holes 111 of the lower metal element 11 to support and position the rotor unit 10 by the injector pin unit 202. Then, the injection mold 2 is operated from the mold opened state to a mold closed state, as shown in FIG. 4.

In step (C), with reference to FIG. 4, a plastic material is injected into the mold cavity 201 of the injection mold 2. The injected plastic material is formed as an overmolding unit 20 which covers the rotor unit 10 and a portion of the injector pin unit 202. The plastic material may be the same as that of the rotor base seat 30, and is acid and alkalis resistant and corrosion resistant. The plastic material may be selected from polypropylene (PP), polyvinylidene difluoride (PVDF) and carbon fiber filled ETFE (CFETFE). The polypropylene has a melting point of 167° C. The polyvinylidene difluoride has a melting point of 171° C. The carbon fiber filled ETFE has a melting point of 256-180° C.

In step (D), the injection mold 2 is cooled, the injection mold 2 is operated from the mold closed state to the mold opened state, and a semi-finished product 100′ is removed from the mold cavity 201. With reference to FIGS. 6 and 10, the overmolding unit 20 of the semi-finished product 100′ has a rotor-side connecting part 21 formed by the injector pin unit 202 and having a plurality of bores 22. The rotor-side connecting part 21 has a bottom end surface 211, a recess 212 recessed from the bottom end surface 211, an inner connected ring 213 projecting from the recess 212, an outer connected ring 214 projecting from the recess 212 and surrounding the inner connected ring 213, and an inner slit 215 formed radially and inwardly of the inner connected ring 213. The recess 212 is confined by a larger-diameter wall 217, a smaller-diameter wall 218, and a shoulder wall 216 interposed between the larger-diameter wall 217 and the smaller-diameter wall 218. The inner connected ring 213 has a primary connected ring portion 219′ and a plurality of secondary connected ring portions 219″ connected with the primary connected ring portion 219′ and angularly spaced apart from each other. The inner slit 215 has an enlarged notch 215′ for engagement with the aligning protrusion 323. The bores 22 are respectively formed within the secondary connected ring portions 219″. Specifically, as shown in FIGS. 4 and 6, the larger-diameter wall 217 is formed by the raised portion 204 of the ejector pin unit 202. The bores 22 are respectively formed by the ejector pins 205 to be stepped bores. The inner slit 215 is formed by the inner surrounding rib 207. The inner connected ring 213 is formed by the primary annular grooved portion 209′ and the secondary annular grooved portions 209″. The outer connected ring 214 is formed by the outer annular groove 210. In addition, the secondary connected ring portions 219″ respectively define the bores 22 therein.

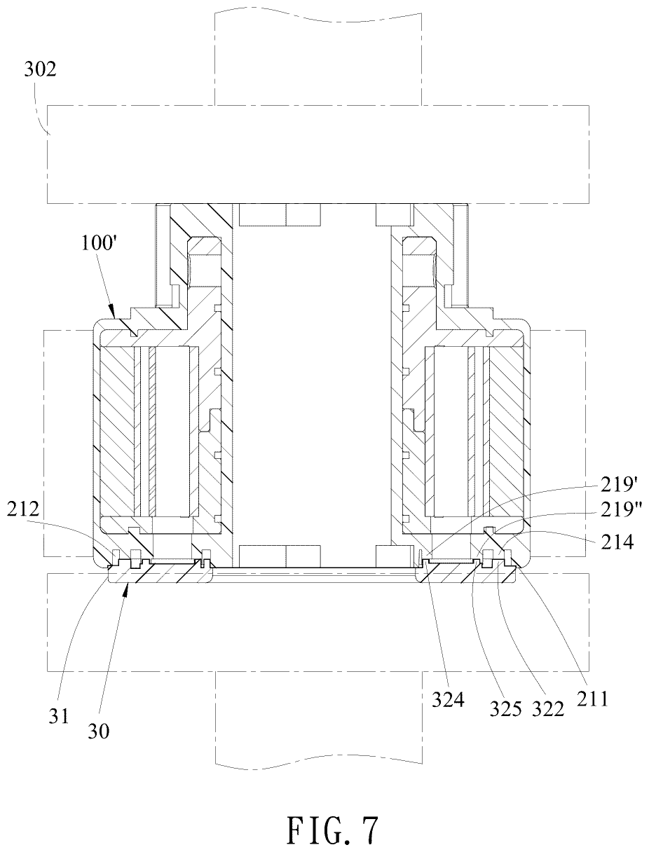

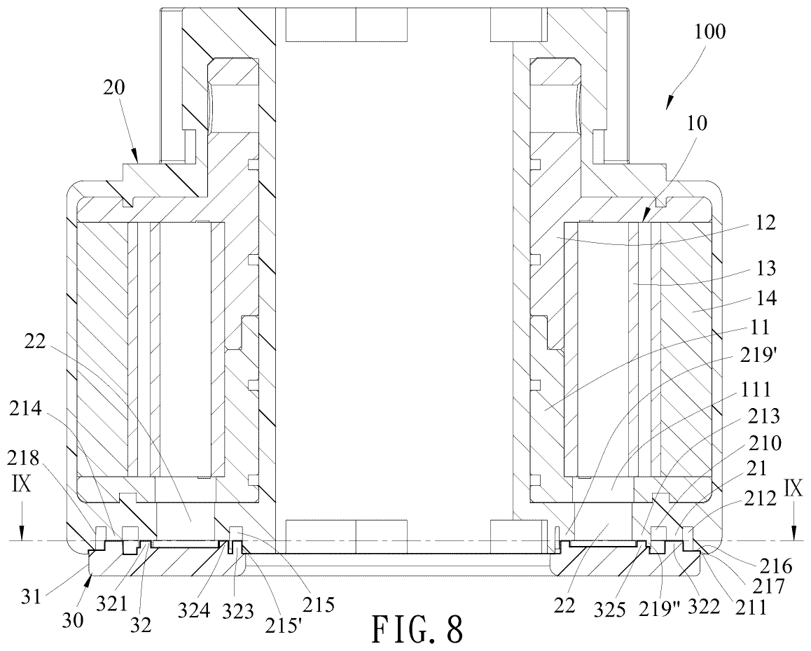

In step (E), referring to FIG. 6, the rotor base seat 30 is disposed on the rotor-side connecting part 21, and the rotor base seat 30 and the semi-finished product 100′ are disposed in the heat press apparatus 3 for performing heating and pressing operations. Specifically, according to the melting point of the material selected for the overmolding unit 20 and the rotor base seat 30, the overmolding unit 20 of the semi-finished product 100′ and the rotor base seat 30 are heated with the heating unit 301 to a predetermined heating temperature. The heating temperature is no greater than 300° C. The heating area includes a portion or an entirety of the contact surfaces of the overmolding unit 20 and the rotor base seat 30. Subsequently, referring to FIG. 7, the heating unit 301 is moved away from the overmolding unit 20 and the rotor base seat 30. The rotor base seat 30 is moved toward the recess 212 of the semi-finished product 100′ through the pressing unit 302. Specifically, the base plate 31 of the rotor base seat 30 abuts against the bottom end surface 211, the seat outer connecting ring 322 abuts against the outer connected ring 214, the primary connecting ring portion 324 abuts against the primary connected ring portion 219′, and the secondary connecting ring portions 324 respectively abut against the secondary connected ring portions 219″. The pressing unit 302 is further operated to perform the pressing process to the rotor base seat 30 and the semi-finished product 100′. The contact area between the rotor base seat 30 and the semi-finished product 100′ has a thermal welding and pressing depth ranging from 0.5 mm to 1 mm. The rotor base seat 30 is bonded to the rotor-side connecting part 21 of the semi-finished product 100′ in thermal welding and pressing processes as the rotor assembly 100 (see FIG. 8).

With reference to FIG. 8, the rotor assembly 100 manufactured by the above method includes the rotor unit 10, the overmolding unit 20 covering the rotor unit 10, and the rotor base seat 30 bonded to the overmolding unit 20.

With reference to FIG. 4, with the ejector pins 205 of the ejector pin unit 202 respectively engaged in the engaging holes 111 of the lower metal element 11, the rotor unit 10 is steadily positioned in the mold cavity 201 during the injection process. Thus, when the plastic material is injected into the mold cavity 201 of the injection mold 2, the rotor unit 10 may be prevented from deflection caused by the injection pressure of the injected plastic material so as to easily control the product quality. In addition, requirement of dynamic balancing of the rotor assembly 100 may be lowered. Corrective measures of the rotor assembly 100 by adding or removing weight thereof may be reduced or eliminated.

With reference to FIG. 6, by virtue of the heating unit 301 heating the overmolding unit 20 of the semi-finished product 100′ and the rotor base seat 30, the contact surfaces of the overmolding unit 20 and the rotor base seat 30 are heated and melted. With reference to FIG. 7, by virtue of the pressing unit 302 pressing the rotor base seat 30 and the semi-finished product 100′, the contact surfaces of the rotor base seat 30 and the semi-finished product 100′ are bonded to each other in the thermal welding and pressing processes. Thus, the rotor assembly 100 is made with a great hermetic sealing effect to prevent chemical fluid leakage into the rotor unit 10, thereby ensuring a long lifespan of the rotor assembly 100.

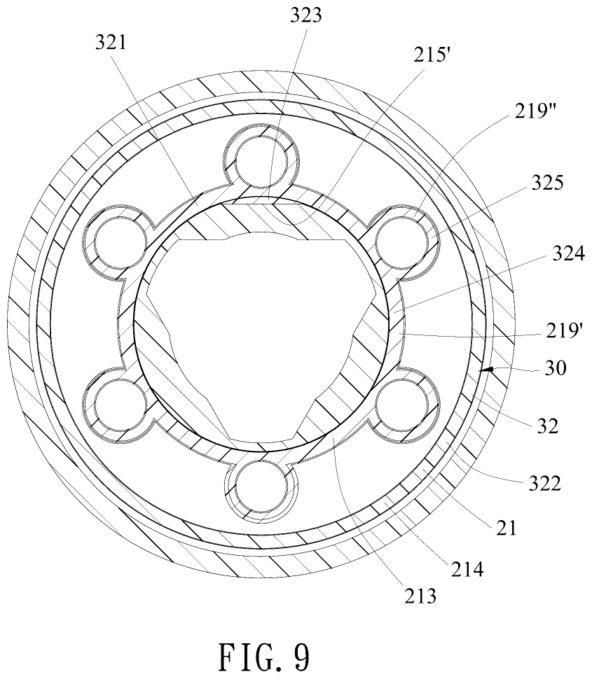

Furthermore, with reference to FIGS. 8 and 9, with the thermal welding bonding between the seat outer connecting ring 322 and the outer connected ring 214, and between the seat inner connecting ring 321 and the connected ring 213, the rotor base seat 30 is sealingly and thermally welded (i.e., bonded) to the overmolding unit 20. The rotor assembly 100 is made with a greater hermetic sealing effect to prevent fluid leakage.

Moreover, by virtue of the engagement of the aligning protrusion 323 with the enlarged notch 215′, the rotor base seat 30 and the semi-finished product 100′ are easily aligned with each other and are correctly disposed within the heat press apparatus 3 for fool-proofing purpose.

Therefore, by using the method of the disclosure for manufacturing the rotor assembly 100, a great hermetic sealing effect of the rotor assembly 100 may be ensured to prevent chemical fluid leakage into the rotor unit 10 when the rotor assembly 100 is immersed in a chemical fluid. In addition, the core of the rotor unit 10 and the overmolding material may be formed with concentricity during injection molding. Hence, the dynamic balance and vibration of the rotor assembly 100 during high speed rotation are kept within a standard range of values, thereby ensuring the long lifespan of the rotor assembly 100.

As illustrated, the steps of the method for manufacturing the rotor assembly 100 of the disclosure are simple and easy to conduct.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A method for manufacturing a rotor assembly of a canned motor pump, comprising:
(A) providing an injection mold, a heat press apparatus, a rotor unit and a rotor base seat, the injection mold having a mold cavity and an injector pin unit securely mounted in the mold cavity, the rotor base seat being made of plastic materials;
(B) disposing the rotor unit in the mold cavity of the injection mold in a mold opened state of the injection mold, wherein the rotor unit is supported and positioned by the injector pin unit, and then operating the injection mold from the mold opened state to a mold closed state;
(C) injecting a plastic material into the mold cavity of the injection mold, the injected plastic material being formed as an overmolding unit which covers the rotor unit and a portion of the injector pin unit;
(D) cooling the injection mold, operating the injection mold from the mold closed state to the mold opened state, and removing a semi-finished product from the mold cavity, the semi-finished product having a rotor-side connecting part formed by the injector pin unit; and
(E) disposing the rotor base seat on the rotor-side connecting part, and disposing the rotor base seat and the semi-finished product in the heat press apparatus for performing heating and pressing operations, the rotor base seat being bonded to the rotor-side connecting part of the semi-finished product in thermal welding and pressing processes.

2. The method of claim 1, wherein the rotor base seat provided in step (A) includes a flat base plate and a seat-side connecting part disposed on the base plate, the seat-side connecting part having a seat inner connecting ring connected with the base plate, and a seat outer connecting ring connected with the base plate and surrounding the seat inner connecting ring,
the rotor-side connecting part of the semi-finished product formed in step (D) having a bottom end surface, a recess recessed from the bottom end surface, an inner connected ring projecting from the recess, and an outer connected ring projecting from the recess and surrounding the inner connected ring, wherein, in step (E), the base plate of the rotor base seat abuts against the bottom end surface, the seat outer connecting ring abuts against the outer connected ring, and the seat inner connecting ring abuts against the inner connected ring.

3. The method of claim 2, wherein the ejector pin unit provided in step (A) has a base frame, a raised portion connected with the base frame, a plurality of ejector pins disposed on the raised portion and angularly spaced apart from each other, an outer surrounding rib disposed on the raised portion and surrounding the ejector pins, an inner surrounding rib disposed on the raised portion and radially and inwardly of the ejector pins, and a surrounding ring disposed on the raised portion and interposed between the outer surrounding rib and the inner surrounding rib, the surrounding ring having an inner peripheral surface which is spaced apart from the inner surrounding rib to define a primary annular grooved portion therebetween, and which is spaced apart from each of the injector pins to define a secondary annular grooved portion therebetween that is in spatial communication with the primary annular grooved portion,
the seat inner connecting ring having a primary connecting ring portion and a plurality of secondary connecting ring portions connected with the primary connecting ring portion and angularly spaced apart from each other,
the inner connected ring of the semi-finished product formed in step (D) having a primary connected ring portion and a plurality of secondary connected ring portions connected with the primary connected ring portion and angularly spaced apart from each other, the secondary connected ring portions respectively defining a plurality of bores, and being respectively aligned with the secondary connecting ring portions,
wherein, in step (E), the primary connecting ring portion and the secondary connecting ring portions are disposed to respectively abut against the primary connected ring portion and the secondary connected ring portions.

4. The method of claim 1, wherein, in step (E), a highest heating temperature in the heating operation is 300° C.

5. The method of claim 1, wherein a thermal welding and pressing depth in the step (E) ranges from 0.5 mm to 1 mm.

6. The method of claim 1, wherein the rotor base seat provided in step (A) is made of a plastic material selected from polypropylene, polyvinylidene difluoride and carbon fiber filled ETFE.
